(19) United States
(12) Patent Application Publication
(10) Pub. No.: US 2012/0185922 A1
(43) Pub. Date: Jul. 19, 2012

(54) Multimedia Management for Enterprises

(76) Inventor: Kiran Kamity, Santa Clara, CA (US)

(21) Appl. No.: 13/347,171

(22) Filed: Jan. 10, 2012

Related U.S. Application Data
(60) Provisional application No. 61/433,254, filed on Jan. 16, 2011.

(51) Int. Cl. G06F 21/00

(52) U.S. Cl. 726/4

(57) ABSTRACT

The embodiments herein disclose a unified method of managing multimedia content in an enterprise using a system that is responsible for streaming, efficient storage, archival, analytics, authentication, creating, editing, sharing, broadcast, and encoding of the content. A unified multimedia appliance is provided within an enterprise cloud, and can provide a single interface for all users across multiple locations within an enterprise. The unified multimedia appliance provides a single appliance or software solution for managing multimedia needs of an enterprise. The appliance provides the convenience of a public cloud based service, but with enhanced security and control over the media content being used and distributed within the enterprise. This appliance could be hosted either inside the enterprise datacenter (private cloud) or could be hosted in the public cloud.

The present application is based on, and claims priority from U.S. Provisional Application No. 61/433,254, filed on 16 Jan, 2011, the disclosure of which is hereby incorporated by reference herein.

### TECHNICAL FIELD

The embodiments herein relate to multimedia content management and, more particularly, to management of multimedia content in an enterprise.

### BACKGROUND

Use of multimedia (video, audio and so on) for communication and entertainment has seen an explosive growth in recent times. The reasons for such rapid growth in use of multimedia can be attributed to easy and cheap availability of storage, general increase in bandwidths available to users, workforces being spread over various geographic areas, and availability of content creations means (such as cameras, microphones and so on) among many other factors.

Enterprises are also trying to use more and more multimedia for the purposes of communication and education. However, in a typical enterprise today, there is no coordination among users in the way they manage multimedia content within the enterprise. The problem is compounded when there are multiple groups within an organization. One group may use a public cloud based service like YOUTUBE. Another group may be using a local server within the enterprise network to store and retrieve their content. The problem with using a cloud based service is that they do not usually suit the security requirements of an enterprise. While services like YOUTUBE do have a facility to share content privately, they require users to register on their platform to avail such services. And, it may not be practical for everyone in a group or even an enterprise to register for a particular service.

Various public cloud based services like YOUTUBE have become popular and are useful to manage multimedia content for individuals within an enterprise. However, such services fall short of catering to the needs of enterprises to control and manage multimedia content in a secure manner within the enterprise.

Integrating a multimedia management solution within an existing enterprise network such as illustrated in FIG. 1 can be a daunting task as such integration may involve adding one or more servers for hosting and streaming video, adding one or more storage appliances, or configuring and using one or more existing storage appliances for video storing/backup, deploying custom application software on one of the servers that can perform tracking of video usage within the enterprise to perform analytics, and security functions like authentication and authorization.

Therefore, there is a need for a simpler and easier to configure solution that provides integration and security along with the convenience of public cloud based services.

### SUMMARY

Embodiments herein disclose a method of managing multimedia content in an enterprise, the method comprising providing an apparatus to host and stream multimedia content, wherein the appliance is further configured to interface with existing authentication systems in the enterprise for authenticating and authorizing multimedia content access within the enterprise.

Embodiments herein disclose an apparatus to host and stream multimedia content, wherein the apparatus is further configured to interface with existing authentication systems in the enterprise for authenticating and authorizing multimedia content access within the enterprise.

Embodiments herein disclose a method of managing multimedia content in an enterprise using at least one Unified Multimedia Appliance (UMA), the method comprising receiving request to store one or more multimedia content on the UMA; performing authentication and authorization of the request by the UMA according to security configuration on the UMA, wherein the security configuration includes configuration to interface with existing authentication systems in the enterprise for authenticating and authorizing multimedia content access within the enterprise; combining the one or more content into a resource of unified format by the UMA; and storing the content of unified format along with analytics information according to storage configuration of the UMA.

Embodiments herein disclose a method of managing multimedia content in an enterprise using at least one Unified Multimedia Appliance (UMA), the method comprising receiving request to access to multimedia content resource by the UMA; performing authentication and authorization of the request by the UMA according to security configuration on the UMA, wherein the security configuration includes configuration to interface with existing authentication systems in the enterprise for authenticating and authorizing multimedia content access within the enterprise; and streaming the multimedia content resource requested by the UMA.

### BRIEF DESCRIPTION OF THE FIGURES

The embodiments herein will be better understood from the following detailed description with reference to the drawings, in which:

FIG. 1 illustrates an enterprise network;

FIG. 2 depicts a unified multimedia appliance in an enterprise cloud connected to a plurality of users spread across multiple locations, according to embodiments as disclosed herein;

FIG. 3 depicts a unified multimedia appliance in an enterprise cloud providing a plurality of views, according to embodiments as disclosed herein;

FIG. 4 depicts a unified multimedia appliance, according to embodiments as disclosed herein;

FIG. 5 depicts a process of processing and storing of content in an organization, according to embodiments as disclosed herein;

FIG. 6 depicts a user requesting for content, according to embodiments as disclosed herein; and

FIG. 7 depicts a user requesting for content, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

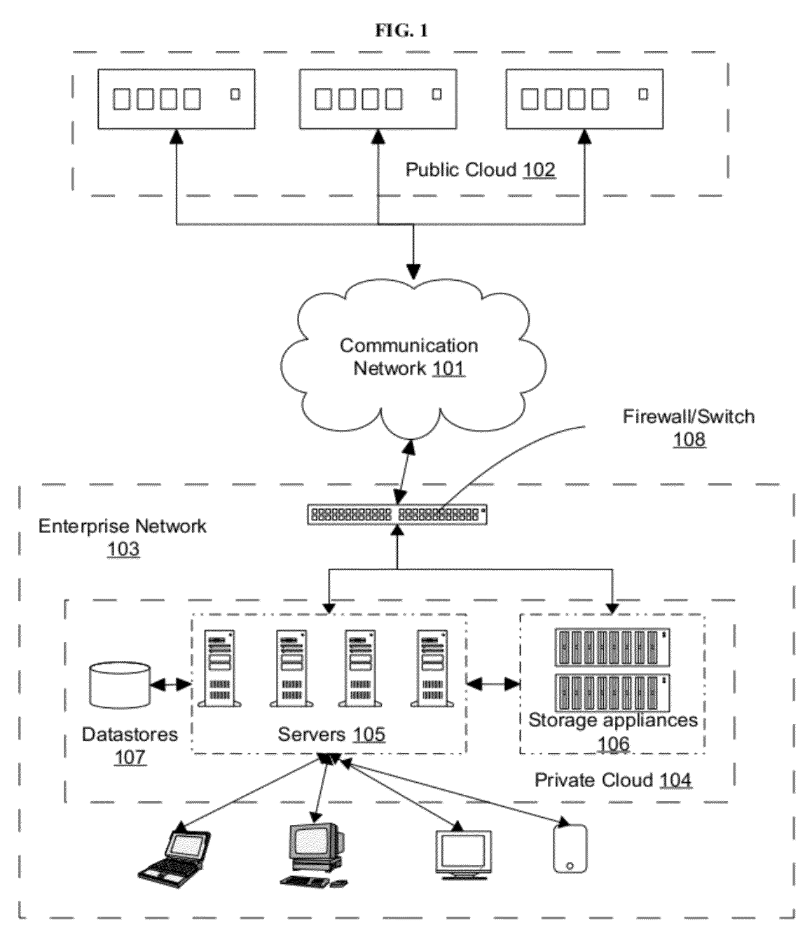

The embodiments herein disclose a unified method of managing multimedia content in an organization using a system that is responsible for efficient storage, archival, analytics, authentication, creation, editing, sharing, broadcast, and encoding of the content. Referring now to the drawings, and more particularly to FIGS. 1 through 7, where similar reference characters denote corresponding features consistently throughout the figures, there are shown embodiments.

FIG. 1 broadly illustrates a communication network 101 connecting a public cloud 102 and an enterprise network 103. Enterprise network 103 can be a complex network with multitude of network elements used for various purposes. In fact, some enterprise networks can be much more complex than as depicted in FIG. 1 as there could multiple locations of offices that are geographically distributed.

With the ever increasing use of multimedia content (example video) as a mode of communication medium, there is an increasing need to access and store videos to enable day to day functions within an enterprise. Today, in a typical enterprise, there is no coordination among users in the way they manage multimedia content within the enterprise. The problem is compounded when there are multiple groups within an organization. One group may use a public cloud based service like YOUTUBE. Another group may be using a local server within the enterprise network to store and retrieve their content. The disparate used for managing multimedia content. The problem with using a cloud based service is that they do not usually suit the security requirements of an enterprise. While services like YOUTUBE do have a facility to share content privately, they require users to register on their platform to avail such services. And, it may not be practical for everyone in a group or even an enterprise to register for a particular service.

Integrating a multimedia management solution within an existing enterprise network such as illustrated in FIG. 1 can be a daunting task as such integration may involve adding one or more servers for hosting and streaming video, adding one or more storage appliances, or configuring and using one or more existing storage appliances for video storing/backup, deploying custom application software on one of the servers that can perform tracking of video usage within the enterprise to perform analytics, and security functions like authentication and authorization.

Therefore, there is a need for a simpler and easier to configure solution that provides integration and security along with the convenience of public cloud based services.

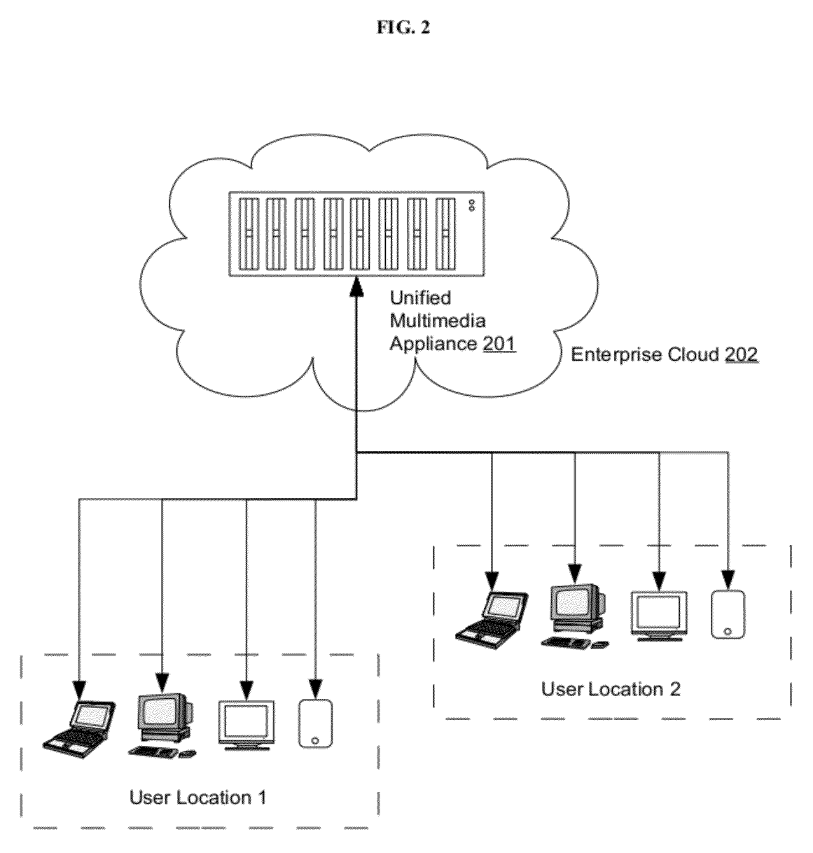

FIG. 2 depicts a unified multimedia appliance in an enterprise datacenter or cloud connected to a plurality of users spread across multiple locations, according to embodiments as disclosed herein. The unified multimedia appliance 201 is present within an enterprise cloud 202, and can provide a single interface for all users across multiple locations within an enterprise. The users may access the cloud using any device capable of connecting to the cloud 202, such as a laptop, desktop, personal computer, tablet, PDA, mobile phone and so on. The users may further comprise of administrators, management and so on. The users may create and edit multimedia content using a browser, standalone application or a widget embedded into other enterprise applications. The multimedia content may comprise of a combination of at least one of audio, video and screen content (text, graphical content, a combination of text and graphics and so on). The user may create and/or edit the content using an application that works from the device used by the user, where the device may accept inputs in the form of a combination of at least one of text, audio and video. The application may comprise but not be limited to a client that works from the browser, a standalone application (wherein the standalone application may be a computer application (which may be running on a computer, tablet, PDA and so on) or an app for a portable device (such as an app for the iPhone, android based devices and so on)), a widget embedded into other applications/tools (where the application/tool may be a browser (Internet Explorer, Firefox, Google Chrome, Safari and so on), an email management application (Outlook, Outlook Express, Thunderbird and so on), an office suite (Microsoft Office, Lotus Notes, OpenOffice.org and so on), a browser based email provider (Gmail, Hotmail, Yahoo and so on), a communication tool (Skype, Microsoft Communicator, Gtalk, Yahoo Messenger and so on), a social networking means (FaceBook, Google+, Linkedin and so on), a customer support tool (SalesForce,

NetSuite and so on), an employee management tool (such as a time sheet tracker, an appraisal tool and so on)). The user may also use a dedicated device such as a multimedia recorder (such as a voice recorder, a video recorder, a transcriber, a scanner and so on). The user may also fetch the content from a remote location using the device. This content may be uploaded onto the appliance 201 using suitable client means, either using streaming or uploading.

The unified multimedia appliance 201 provides a single appliance solution for managing multimedia needs of an enterprise. The appliance 201 provides the convenience of a public cloud based service, but with enhanced security and control over the media content being used and distributed within the enterprise. In various embodiments, the appliance 201 may provide the following facilities:

Automatic Video Merging to a Unified Format: The unified multimedia appliance 201 may merge multiple types of content based on user input and/or transcode/convert the content into a pre-specified format. For example, user may provide multiple files or sources as input. The appliance 201 fetches all the input files and merges them to a single file to a pre-specified format. Examples of various file formats that can be combined include, but are not limited to, video files such as WINDOWS MEDIA VIDEO, and REAL MEDIA VIDEO; slide show files PPS, PPT, and ODP; Image formats such as JPEG, BMP, GIF; audio files such as WMA, AMR, and so on.

Hosting/Streaming in a Unified Format: In a preferred embodiment, the format to which content is converted to may be uniform (such as H264) for all content associated with the multimedia appliance 201 across the enterprise. In various other embodiments, the format to which a file is converted to may vary based on user requirements, including but not limited to nature of content, the purpose of the content, associated tags, the department from which the file is uploaded, and so on. For example, if a video uploaded is to be used for training purposes, such a video may be given higher preference and therefore may be stored in a format that provides higher quality as compared to a video that is for the purposes of fun and entertainment.

The unified multimedia appliance 201 enables users to access content by streaming the content to the users, after authenticating and authorizing the users. The unified multimedia appliance 201 may fetch requested content from an internal storage means. The unified multimedia appliance 201 may also fetch requested content from an external storage means.

Content Tagging: The unified multimedia appliance 201 may also tag the content. The tags may depend on the content, the user who uploaded the content, the date and time the content was created and uploaded, additional information associated to the video by the user, explicit tags information provided by the user, and so on.

Storage and Backup: The unified multimedia appliance 201 can act as a storage appliance and provide storage and backup facilities like an off-the-shelf storage appliance. In this case, all the multimedia as well as metadata information (title/description/tags/analytics etc . . . ) is stored in the appliance. This data can be stored either as flat files or inside a database. This data can also be replicated/backed up on a periodic basis for failover and redundancy. In various embodiments, the appliance 201 can be built to work with an existing storage appliance, such as the appliances provided by HP, NETAPP, EMC2 and so on. In this case, the appliance (201) will redirect all storage to a different storage appliance (NAS/SAN/Windows File Servers etc . . . ), most likely one that is already being used by the enterprise. In this case, redundancy/failover (replication or backup) are handled by this 3^{rd} party appliance/software. This is especially true if the appliance (201) is a software install or a virtual machine.

In various embodiments, the appliance may store information locally based on appliance configuration. In some embodiments, the appliance may be configured to connect to an external storage appliance or a storage device.

Further, in some embodiments, automatic backups of content to an internal storage means may be enabled. In some other embodiments, the unified multimedia appliance 201 may also take backups of content to an external storage and/or backup means.

Analytics: The unified multimedia appliance 201 may also collect and store analytics related to the accessing of content, such as the number of times a specific content has been accessed, the dates and times of access, the list of users accessing a specific content, the location of users accessing information within the enterprise, and so on.

Authentication and Authorization using existing enterprise user authentication infrastructure: In present systems, IT administrators use a plurality of means for managing media at the same time, and one of the critical issues with such an ad-hoc approach is the difficulty to control and manage content at a single place. In a preferred embodiment, the appliance 201 automatically connects to standards based authentication means within an enterprise to provide authentication and authorization for media content upload and access across the enterprise without any additional setup. The appliance 201 can connect to existing authentication systems like LDAP, Microsoft's Active Directory, Novell's Netware/Directory Services and so on. With such integration, users within an enterprise need not provide special credentials to access content. Also, authorization can be managed using these existing groups (such as Active Directory groups) The appliance automatically fetches information about the user from existing systems and therefore, provides greater convenience and efficiency in managing and controlling the multimedia activity within the enterprise.

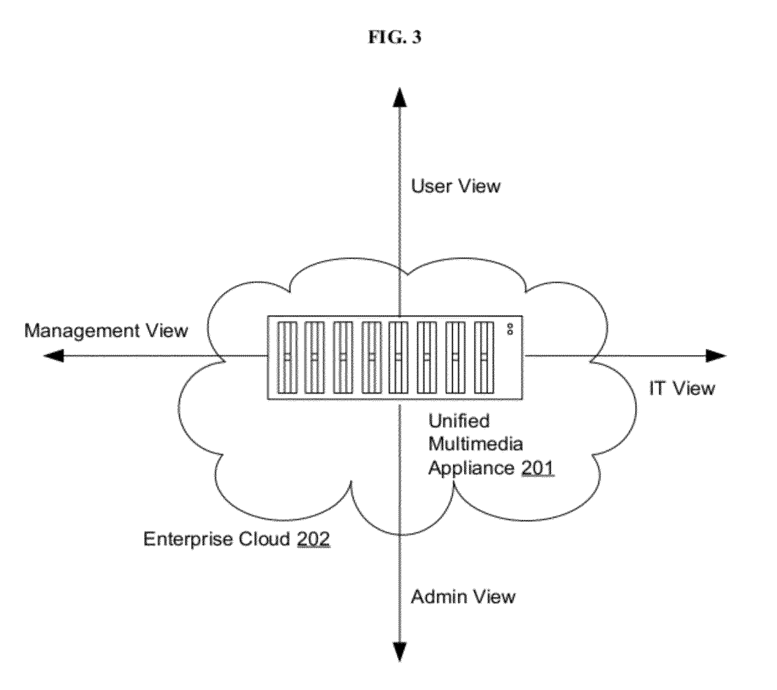

FIG. 3 depicts a unified multimedia appliance in an enterprise cloud providing a plurality of views, according to embodiments as disclosed herein. The unified multimedia appliance 201 provides distinct interfaces for users, administrators and management to access the unified multimedia appliance 201. The user interface may comprise of a means for a user to create/edit/access/view the content. The user interface may be a web application based interface, a standalone interface or a widget embedded into other applications or websites. The administrator view provides an interface for an administrator to control the unified multimedia appliance 201. The administrator may control factors such as the type of format in which content is to be stored, the tags associated with the content, the location where the content is to be stored, the location to where the content is to be backed up and so on. The administrator may also access the analytics collected by the unified multimedia appliance 201 and perform further operations on the same. The Management view enables people from the management to view analytics collected by the unified multimedia appliance 201 and perform further operations on the same. The IT view enables the appliance 201 to interact with existing network infrastructure, such as storage, backup and authentication means exiting in the network.

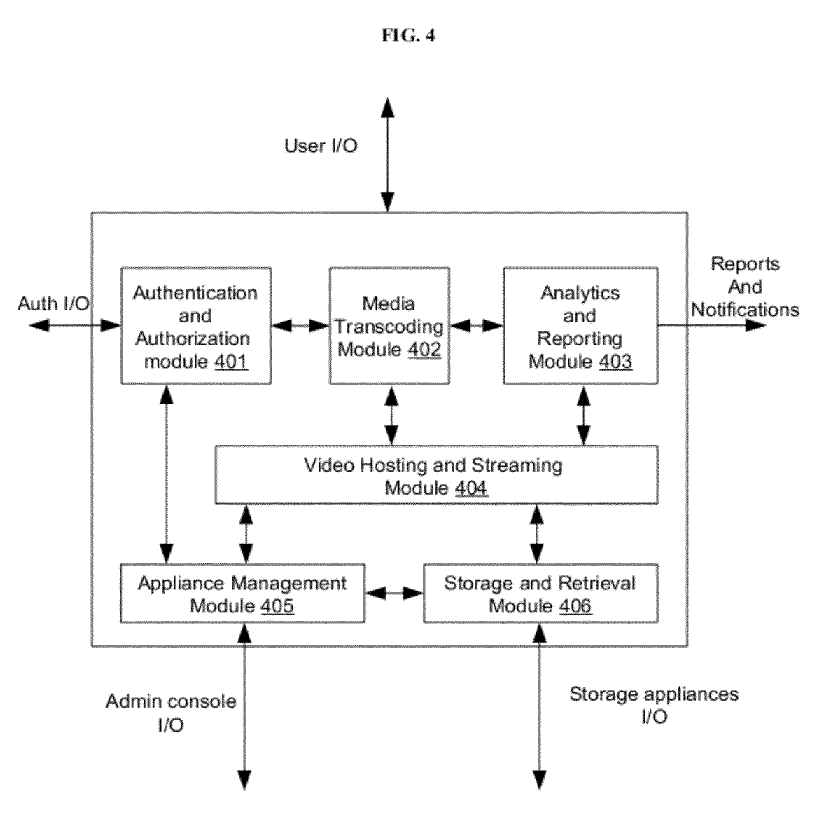

FIG. 4 depicts a unified multimedia appliance, according to embodiments as disclosed herein. The unified multimedia appliance 201 comprises of an authentication and authorization module 401, a media transcoding module 402, an analytics and reporting module 403, a video hosting and streaming module 404, an appliance management module 405 and a storage and retrieval module 406. The unified multimedia appliance 201 also comprises of a plurality of interfaces such as a user interface, an authorization interface, an admin console interface, a storage appliances interface and a reports and notification interface.

On a user requesting for content from the unified multimedia appliance 201, the authentication and authorization module 401 verifies if the user is authorized to access the appliance 201. The authentication and authorization module 401 may access an external module for the verification. The authentication and authorization module 401 may verify if the user logging in qualifies for the role of an administrator and/or management before permitting access to the appliance 201. The authentication and authorization module 401 may also be responsible for deciding the level access of the user/administrator/management depending on the roles and capabilities of the person accessing the appliance 201.

The media transcoding module 402 transcodes content from one format to the standard format. The media transcoding module 402 may also merge content from various sources and platforms and/or transcode content into a uniform format. This is usually done to enable better streaming over high latency or low bandwidth connections. In an embodiment herein, the uniform format may be H.264 format. The media transcoding module 402 may transcode the content, when the content is being received by the appliance 201. The media transcoding module 402 may also transcode the content on receiving an instruction from the administrator or the user. The media transcoding module 402 may transcode the content format with the objective of being able to consume least storage footprint while providing a format that is viewable on multiple end user devices using a standard means. The media transcoding module 402 may also tag the content depending on the content, the user who uploaded the content, the date and time the content was created and uploaded and so on. It may also extract the audio from the content and convert it to text for better search/tagging/indexing,

The analytics and reporting module 403 enables the appliance 201 to collect analytics regarding the content. The analytics may comprise of content such as the number of times a specific content has been accessed, the dates and times of access, the list of users accessing a specific content and so on. The analytics and reporting module 403 may also create reports based on the analytics, on receiving appropriate instructions from the management or the administrator.

The video hosting and streaming module 404 handles streaming of the content to the user using a suitable means. The video hosting and streaming module 404 may also enable creation of content. The video hosting and streaming module 404 fetches the content via the storage and retrieval module 406. The storage and retrieval module 406 may fetch the content from an internal storage means or an external storage means. The storage and retrieval module 406 may be compatible with storage technologies such as RAID (Redundant Array Of Independent Disks). The video hosting and streaming module 404 may stream the content to the user using a standalone application or a browser based application. Depending on the connection or configuration settings, this module might perform streaming or progressive download.

The appliance management module 405 manages the appliance 201. The appliance management module 405 controls the streaming of content to the user. The appliance management module 405 also controls the creation of content, transformation of the content, storage of the content and so on. The appliance management module 405 stores the content in the appropriate location (may be an internal location or an external location). The appliance management module 405 also takes backup of the content to the appropriate location (may be an internal location or an external location).

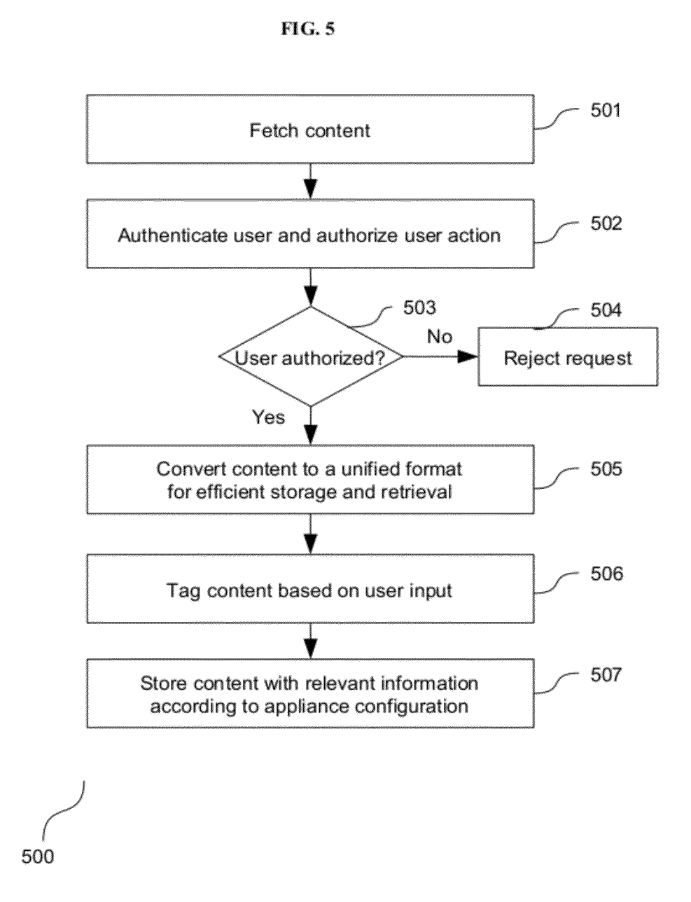

FIG. 5 depicts a process of processing and storing of content in an organization, according to embodiments as disclosed herein. The unified multimedia appliance 201 fetches (501) the content. The content may be fetched from another location accessible to the unified multimedia appliance 201. The content may also be created by a user/administrator/management using an interface made available by the unified multimedia appliance 201. The unified multimedia appliance 201 authenticates (502) the user action. The unified multimedia appliance 201 may leverage internal database or other enterprise authentication mechanisms (such as LDAP, Active Directory etc.) for authentication. The unified multimedia appliance 201 may also use an internal authentication means for authentication. If the user is not authorized (503), the unified multimedia appliance 201 denies (504) permission to the user to access the unified multimedia appliance 201. If the user is authorized (503), the unified multimedia appliance 201 converts (505) the content into a unified format. The content may be merged with other content. In an embodiment herein, the unified format may be H.264. The unified multimedia appliance 201 further tags (506) the content in an appropriate manner. The tags may depend on the content, the user who uploaded the content, the date and time the content was created and uploaded and so on. The unified multimedia appliance 201 further stores (507) the content with related information in a suitable location (may be internal to the unified multimedia appliance 201 or external to the unified multimedia appliance 201). The various actions in method 500 may be performed in the order presented, in a different order or simultaneously. Further, in some embodiments, some actions listed in FIG. 5 may be omitted.

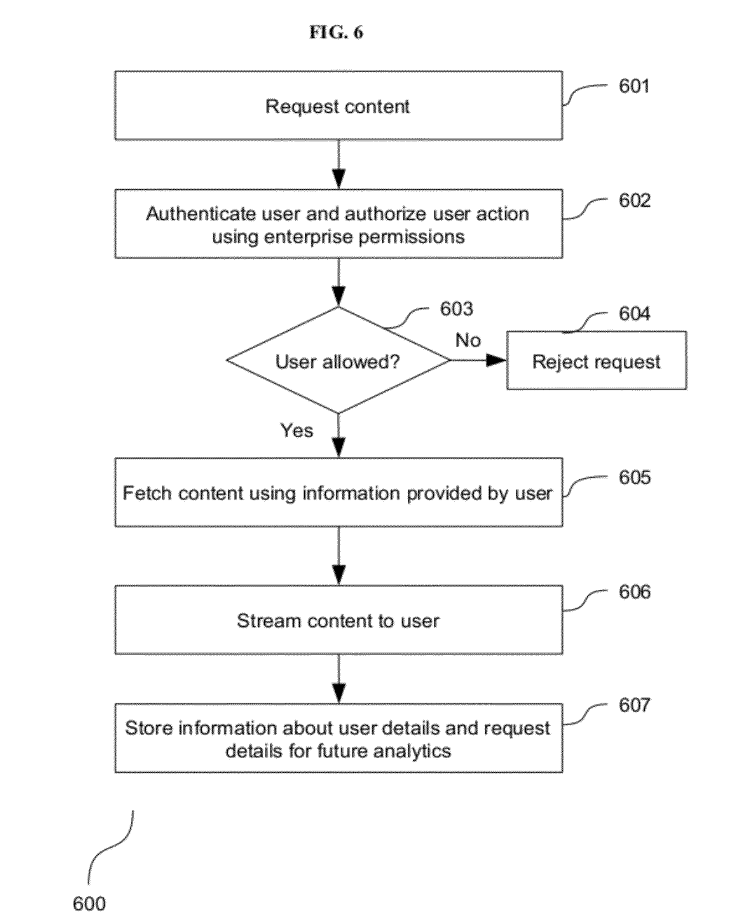

FIG. 6 depicts a user requesting for content, according to embodiments as disclosed herein. On a user requesting (601) content, the unified multimedia appliance 201 authenticates (602) the user action. The unified multimedia appliance 201 may use an external authentication means for authentication. The unified multimedia appliance 201 may also use an internal authentication means for authentication. If the user is not authorized (603), the unified multimedia appliance 201 denies (604) permission to the user to access the unified multimedia appliance 201. If the user is authorized (603), the unified multimedia appliance 201 fetches (605) the content as requested by the user. The The unified multimedia appliance 201 authenticates (502) the user action. The unified multimedia appliance 201 may use an external authentication means for authentication. The unified multimedia appliance 201 may also use an internal authentication means for authentication. If the user is not authorized (503), the unified multimedia appliance 201 denies (504) permission to the user to access the unified multimedia appliance 201. If the user is authorized (503), the unified multimedia appliance 201 fetches (605) the content and streams (606) the content to the user using a suitable means. The unified multimedia appliance 201 may fetch the content from an internal storage means or an external storage means. The unified multimedia appliance 201 further stores (607) information about the user and the request. The various actions in method 600 may be performed in the order presented, in a different order or simultaneously. Further, in some embodiments, some actions listed in FIG. 6 may be omitted.

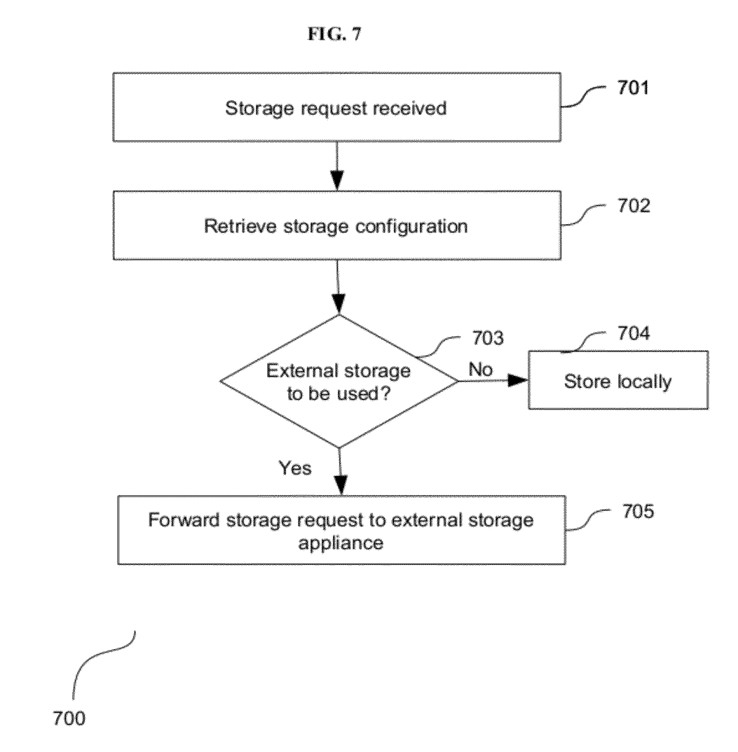

FIG. 7 depicts a user requesting for content, according to embodiments as disclosed herein. On the unified multimedia appliance 201 receiving (701) a request for storage, the unified multimedia appliance 201 retrieves (702) the storage configuration. The storage configuration may be as set by the administrator and may vary depending on the type of content, source of the content, time of upload and so on. On retrieving the storage configuration, the unified multimedia appliance 201 checks (703) if external storage is to be used. If external storage is to be used, the unified multimedia appliance 201 forwards (705) the storage request to the corresponding external storage appliance. If external storage is not to be used, the unified multimedia appliance 201 stores (704) the content locally. The various actions in method 700 may be performed in the order presented, in a different order or simultaneously. Further, in some embodiments, some actions listed in FIG. 7 may be omitted.

The embodiments disclosed herein can be implemented through at least one software program running on at least one hardware device and performing network management functions to control the network elements. The network elements shown in FIG. 1 and FIG. 2 include blocks which can be at least one of a hardware device, or a combination of hardware device and software module.

The embodiments disclosed herein specify a system for managing multimedia content within enterprises. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means (where the software means may be delivered in the form of a software application that can be installed on a general purpose Windows/*nix server/desktop Operating System). Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of managing multimedia content in an enterprise, said method comprising
providing an apparatus to host and stream multimedia content, wherein said appliance is further configured to interface with existing authentication systems in said enterprise for authenticating and authorizing multimedia content access within said enterprise.

2. The method, as claimed in claim 1, said method further comprising providing said apparatus to tag said multimedia content.

3. The method, as claimed in claim 1, said method further comprising providing said apparatus to backup said multimedia content.

4. The method, as claimed in claim 1, said method further comprising providing said apparatus to collect analytic information related to said multimedia content.

5. An apparatus to host and stream multimedia content, wherein said apparatus is further configured to interface with existing authentication systems in said enterprise for authenticating and authorizing multimedia content access within said enterprise.

6. The apparatus, as claimed in claim 5, said apparatus further configured to tag said multimedia content.

7. The apparatus, as claimed in claim 5, said apparatus further configured to backup of said multimedia content.

8. The apparatus, as claimed in claim 5, said apparatus further configured to collect analytic information related to said multimedia content.

9. A method of managing multimedia content in an enterprise using at least one Unified Multimedia Appliance (UMA), said method comprising
Receiving request to store one or more multimedia content on said UMA;
Performing authentication and authorization of said request by said UMA according to security configuration on said UMA, wherein said security configuration includes configuration to interface with existing authentication systems in said enterprise for authenticating and authorizing multimedia content access within said enterprise;
Combining said one or more content into a resource of unified format by said UMA; and
Storing said content in unified format along with analytics information according to storage configuration of said UMA.

10. The method, as claimed in claim 9, wherein said multimedia content is being generated by a user.

11. The method, as claimed in claim 10, wherein said user generates said multimedia content using at least one of
a client that works from a browser present within a device used by said user;
a standalone application present within a device used by said user;
a widget embedded into other applications/tools;
an employee management tool; or
a dedicated device.

12. The method, as claimed in claim 11, wherein said standalone application may be at least one of
a computer application; or
an app for a portable device.

13. The method, as claimed in claim 9, wherein said multimedia content is fetched by a user.

14. The method, as claimed in claim 9, said method further comprising of tagging said resource of unified format by said UMA, before storing said resource of unified format.

15. The method, as claimed in claim 9, said method further comprising of taking backup of said resource of unified format and said analytics information by said UMA.

16. The method, as claimed in claim 9, wherein said analytic information comprises of
number of times said resource of unified format has been accessed;
dates and times of access of said resource of unified format;
list of users accessing said resource of unified format; and
location of users accessing said resource of unified format within said enterprise.

17. The method, as claimed in claim 9, said method further comprising of creating reports based on said analytic information by said UMA.

18. A method of managing multimedia content in an enterprise using at least one Unified Multimedia Appliance (UMA), said method comprising
Receiving request to access to multimedia content resource by said UMA;
Performing authentication and authorization of said request by said UMA according to security configuration on said UMA, wherein said security configuration includes configuration to interface with existing authentication systems in said enterprise for authenticating and authorizing multimedia content access within said enterprise; and
Streaming said multimedia content resource requested by said UMA.

19. The method, as claimed in claim 18, said method further comprising of collecting analytic information by said UMA.

20. The method, as claimed in claim 19, wherein said analytic information comprises of
number of times said resource of unified format has been accessed;
dates and times of access of said resource of unified format;
list of users accessing said resource of unified format; and
location of users accessing said resource of unified format within said enterprise.
